(19) United States
(12) Patent Application Publication
(10) Pub. No.: US 2024/0319399 A1
(43) Pub. Date: Sep. 26, 2024

(54) System and Method for Locating Undocumented Orphaned Oil and Gas Wells with a Smartphone

(71) Applicant: The Board of Regents of the University of Oklahoma, Norman, OK (US)

(72) Inventor: Sina Saneiyan, Norman, OK (US)

(73) Assignee: The Board of Regents of the University of Oklahoma, Norman, OK (US)

(21) Appl. No.: 18/444,665

(22) Filed: Feb. 17, 2024

Related U.S. Application Data
(60) Provisional application No. 63/446,442, filed on Feb. 17, 2023.

(51) Int. Cl. G01V 3/08; G01V 3/16; G01V 3/38

(52) U.S. Cl. CPC G01V 3/087; G01V 3/16; G01V 3/38

(57) ABSTRACT

A cost-effective aerial detector device is configured to locate ferromagnetic objects in a survey area. The aerial detector device includes a UAV, a sensor housing suspended from the UAV, and the sensor module inside the sensor housing. The sensor module can be a smartphone that includes a magnetometer and a GPS unit. A method for locating a ferromagnetic target within the survey area includes the steps of launching the aerial detector device into the survey area, activating the magnetometer and GPS unit on the smartphone to obtain magnetic field measurements and location information, correlating the magnetic field measurements with corresponding location information to produced geolocated magnetic field data, identifying geolocated magnetic anomaly data from the geolocated magnetic field data, identifying one or more magnetic anomaly signatures for the ferromagnetic target, and determining the location of the ferromagnetic target from the location information associated with the target magnetic anomaly signature.

### RELATED APPLICATIONS

The present application claims the benefit of U.S. Provisional Patent Application Ser. No. 63/446,442 filed Feb. 17, 2023 entitled “System and Method for Locating Undocumented Orphaned Oil and Gas Wells with a Smartphone,” the disclosure of which is herein incorporated by reference in its entirety.

### BACKGROUND OF THE INVENTION

Orphaned oil and gas wells are abandoned wells that are left in the ground by defunct companies that cannot plug and remediate them. According to the Department of Interior, nearly 130,000 documented wells exist in the U.S.; however, the number of undocumented wells is estimated by the Environmental Protection Agency to be between two and three million. These wells are a great contributor to greenhouse gas (particularly methane) emissions with some of them producing 10 times more greenhouse gases than remediated or active wells.

Most orphaned wells still have alloy steel casing and tubing in the ground, and some orphaned wells still have a wellhead extending upward out of the ground. Because many of these wells are more than 100 years old, they are rusted, destroyed or collapsed and are difficult to visibly notice and locate without the help of advanced sensing tools. This exacerbates the fugitive emission of greenhouse gases by these wells. Whether the goal is to plug and remediate the orphaned well or repurpose them for geothermal energy production, locating the orphaned wells is a high priority.

Existing methods to locate orphaned wells include review of historical ownership, production, and land use records, observational studies (e.g., soil and bedrock studies, mapping anthropogenic features and surface cover, and nearby water well history), ground based geophysical methods (e.g., ground penetrating radar, electrical resistivity tomography and induced polarization, electromagnetic induction imaging, seismic refraction tomography, magnetometry and excavation) and aerial surveys (e.g., drone based magnetometry, LiDAR scanning for surface anomalies related to drilling, gravimetry). Unfortunately, there are significant hurdles to locating these wells, including missing ownership records of the wells, lost records for the removal of surface equipment, overgrown vegetation hiding the wells, and inaccessibility of the sites where such wells exist.

Although aerial-based magnetometry methods show promise, existing methods rely on expensive and complicated equipment, which is often cost prohibitive given the limited financial resources available for locating and plugging unproductive orphaned wells. There is, therefore, a compelling need for an aerial system for locating orphaned wells that overcomes the deficiencies of existing technologies.

### BRIEF DESCRIPTION OF DRAWINGS

The accompanying drawings, which are incorporated in and constitute a part of this specification, illustrate one or more implementations described herein and, together with the description, explain these implementations. The drawings are not intended to be drawn to scale, and certain features and certain views of the figures may be shown exaggerated, to scale, or in schematic in the interest of clarity and conciseness.

FIG. 1 depicts an orphaned well that is obscured by overgrown vegetation.

FIG. 2 depicts an aerial detector device constructed in accordance with exemplary embodiments.

FIGS. 3A-3B provide front and back depictions of a sensor module that includes a magnetometer.

FIGS. 4A-4B provide top and bottom depictions of a sensor housing for securing the sensor module of FIGS. 3A-3B within the aerial detector device.

FIGS. 4C-4D present side and end cross-sectional views of the sensor housing for securing the sensor module of FIGS. 3A-3B within the aerial detector device.

FIG. 5 is a flowchart for a method of locating orphaned wells using the aerial detector device of FIG. 2.

FIGS. 6A-6C depict a graphic output from the aerial detector device used to identify of an orphaned well.

FIGS. 6D-6F provide sample outputs of well signature anomaly data for a well using geolocated magnetic field measurements taken by the aerial detector device.

### DETAILED DESCRIPTION

The present disclosure is generally directed at a system and method for detecting and locating ferromagnetic objects or targets located on or under the ground with an aerial magnetometry detector device. In some embodiments, the aerial detector device includes an unmanned aerial vehicle (UAV), a portable magnetometer, and a harness assembly for hanging the magnetometer from the UAV. The aerial detector device is well suited for identifying oil wells or other equipment and structures that include magnetically permeable materials that produce a magnetic anomaly signature.

Before describing various embodiments of the present disclosure in more detail by way of exemplary description, examples, and results, it is to be understood that the embodiments of the present disclosure are not limited in application to the details of methods and apparatus as set forth in the following description. The embodiments of the present disclosure are capable of other embodiments or of being practiced or carried out in various ways. As such, the language used herein is intended to be given the broadest possible scope and meaning; and the embodiments are meant to be exemplary, not exhaustive. Also, it is to be understood that the phraseology and terminology employed herein is for the purpose of description and should not be regarded as limiting unless otherwise indicated as so. Moreover, in the following detailed description, numerous specific details are set forth in order to provide a more thorough understanding of the disclosure. However, it will be apparent to a person having ordinary skill in the art that certain embodiments of the present disclosure can be practiced without these specific details. In other instances, features which are well known to persons of ordinary skill in the art have not been described in detail to avoid unnecessary complication of the description.

Unless otherwise defined herein, scientific and technical terms used in connection with the embodiments of the present disclosure shall have the meanings that are commonly understood by those having ordinary skill in the art. Further, unless otherwise required by context, singular terms shall include pluralities and plural terms shall include the singular.

All patents, published patent applications, and non-patent publications mentioned in the specification are indicative of the level of skill of those skilled in the art to which embodiments of the present disclosure pertain. All patents, published patent applications, and non-patent publications referenced in any portion of this application are herein expressly incorporated by reference in their entirety to the same extent as if each individual patent or publication was specifically and individually indicated to be incorporated by reference.

While the methods and apparatus of the embodiments of the present disclosure have been described in terms of particular embodiments, it will be apparent to those of skill in the art that variations may be applied thereto and in the steps or in the sequence of steps of the methods described herein without departing from the spirit and scope of the inventive concepts. All such similar substitutes and modifications apparent to those skilled in the art are deemed to be within the spirit and scope of the systems as defined herein.

As utilized in accordance with the methods and apparatus of the embodiments of the present disclosure, the following terms, unless otherwise indicated, shall be understood to have the following meanings. The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or when the alternatives are mutually exclusive, although the disclosure supports a definition that refers to only alternatives and “and/or.” The use of the term “at least one” will be understood to include one as well as any quantity more than one, including but not limited to, 2, 3, 4, 5, 6, 7, 8, 9, 10, 15, 20, 30, 40, 50, 100, or any integer inclusive therein. The term “at least one” may extend up to 100 or 1000 or more, depending on the term to which it is attached; in addition, the quantities of 100/1000 are not to be considered limiting, as higher limits may also produce satisfactory results. In addition, the use of the term “at least one of X, Y and Z” will be understood to include X alone, Y alone, and Z alone, as well as any combination of X, Y and Z.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AAB, BBC, AAABCCCC, CBBAAA, CABABB, and so forth. The skilled artisan will understand that typically there is no limit on the number of items or terms in any combination, unless otherwise apparent from the context.

Throughout this application, the terms “about” or “approximately” are used to indicate that a value includes the inherent variation of error. Further, in this detailed description, each numerical value (e.g., time or frequency) should be read once as modified by the term “about” (unless already expressly so modified), and then read again as not so modified unless otherwise indicated in context. The use of the term “about” or “approximately” may mean a range including ±0.5%, or ±1%, ±2%, or ±3%, or ±4%, or ±5%, ±6%, or ±7%, or ±8%, or ±9%, or ±10%, or ±11%, or ±12%, or ±13%, or ±14%, or ±15%, or ±25% of the subsequent number unless otherwise stated.

As used herein, the term “substantially” means that the subsequently described event or circumstance completely occurs or that the subsequently described event or circumstance occurs to a great extent or degree. For example, the term “substantially” means that the subsequently described event or circumstance occurs at least 80% of the time, or at least 90% of the time, or at least 95% of the time, or at least 98% of the time.

Features of any of the embodiments described herein may be combined with any of the other embodiments to create a new embodiment. As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, all numerical values or ranges include fractions of the values and integers within such ranges and fractions of the integers within such ranges unless the context clearly indicates otherwise. Thus, to illustrate, reference to a numerical range, such as 1-10 includes 1, 2, 3, 4, 5, 6, 7, 8, 9, 10, as well as 1.1, 1.2, 1.3, 1.4, 1.5, etc., and so forth. Reference to a range of 1-50 therefore includes 1, 2, 3, 4, 5, 6, 7, 8, 9, 10, 11, 12, 13, 14, 15, 16, 17, 18, 19, 20, etc., up to and including 50. Similarly, fractional amounts between any two consecutive integers are intended to be included herein, such as, but not limited to, 0.05, 0.1, 0.15, 0.2, 0.25, 0.3, 0.35, 0.4, 0.45, 0.5, 0.55, 0.6, 0.65, 0.7, 0.75, 0.8, 0.85, 0.9, and 0.95. For example, the range 3 to 4 includes, but is not limited to, 3.05, 3.1, 3.15, 3.2, 3.25, 3.3, 3.35, 3.4, 3.45, 3.5, 3.55, 3.6, 3.65, 3.7, 3.75, 3.8, 3.85, 3.9, and 3.95. Thus, even if specific data points within the range, or even no data points within the range, are explicitly identified or specifically referred to, it is to be understood that any data points within the range are to be considered to have been specified, and that the inventors possessed knowledge of the entire range and the points within the range.

Reference to a series of ranges includes ranges which combine the values of the boundaries of different ranges within the series. For example, “a range from 1 to 10” is to be read as indicating each possible number, particularly integers, along the continuum between about 1 and about 10. Thus, even if specific data points within the range, or even no data points within the range, are explicitly identified or specifically referred to, it is to be understood that any data points within the range are to be considered to have been specified, and that the inventors possessed knowledge of the entire range and the points within the range.

Thus, to further illustrate reference to a series of ranges, for example, a range of 1-1,000 includes, for example, 1-10, 10-20, 20-30, 30-40, 40-50, 50-60, 60-75, 75-100, 100-150, 150-200, 200-250, 250-300, 300-400, 400-500, 500-750, 750-1,000, and includes ranges of 1-20, 10-50, 50-100, 100-500, and 500-1,000. The range 100 units to 2000 units therefore refers to and includes all values or ranges of values of the units, and fractions of the values of the units and integers within said range, including for example, but not limited to 100 units to 1000 units, 100 units to 500 units, 200 units to 1000 units, 300 units to 1500 units, 400 units to 2000 units, 500 units to 2000 units, 500 units to 1000 units, 250 units to 1750 units, 250 units to 1200 units, 750 units to 2000 units, 150 units to 1500 units, 100 units to 1250 units, and 800 units to 1200 units. Any two values within the range of about 100 units to about 2000 units therefore can be used to set the lower and upper boundaries of a range in accordance with the embodiments of the present disclosure.

The present disclosure will now be discussed in terms of several specific, non-limiting, examples, and embodiments. The examples described below, which include particular embodiments, will serve to illustrate the practice of the present disclosure, it being understood that the particulars shown are by way of example and for purposes of illustrative discussion of particular embodiments and are presented in the cause of providing what is believed to be a useful and readily understood description of procedures as well as of the principles and conceptual aspects of the present disclosure.

Magnetic surveying methods are well-established techniques for identifying ferromagnetic anomalies in the subsurface of the Earth. These methods are used for a variety of applications including mapping unique geologic features (e.g., mafic dykes), finding unexploded ordnance (UXO) objects, and locating iron ore for mineral exploration. Magnetic surveying techniques have also been used in various environmental applications, including in locating abandoned oil and gas wells. The magnetic measurements are collected through different methods, but each method relies on the measurement of changes or anomalies in the Earth's magnetic field. Magnetic anomalies usually appear as dipoles on magnetic maps. However, in cases where the anomaly is based on a vertical structure (e.g., the steel casing of a traditional oil and gas well) they can appear as monopoles. The magnetic field is a vector measured in x, y, z directions. Therefore, the total magnetic intensity (Bt) of the Earth at any location is expressed as:

$$\\ \begin{matrix}{B}_{t} = \sqrt{{B}_{x}^{{}_{} 2} + {B}_{y}^{{}_{} 2} + {B}_{z}^{{}_{} 2}} , & ( 1 )\end{matrix}$$

where Bx, By and Bz are the vector components of magnetic field, units of Tesla (T).

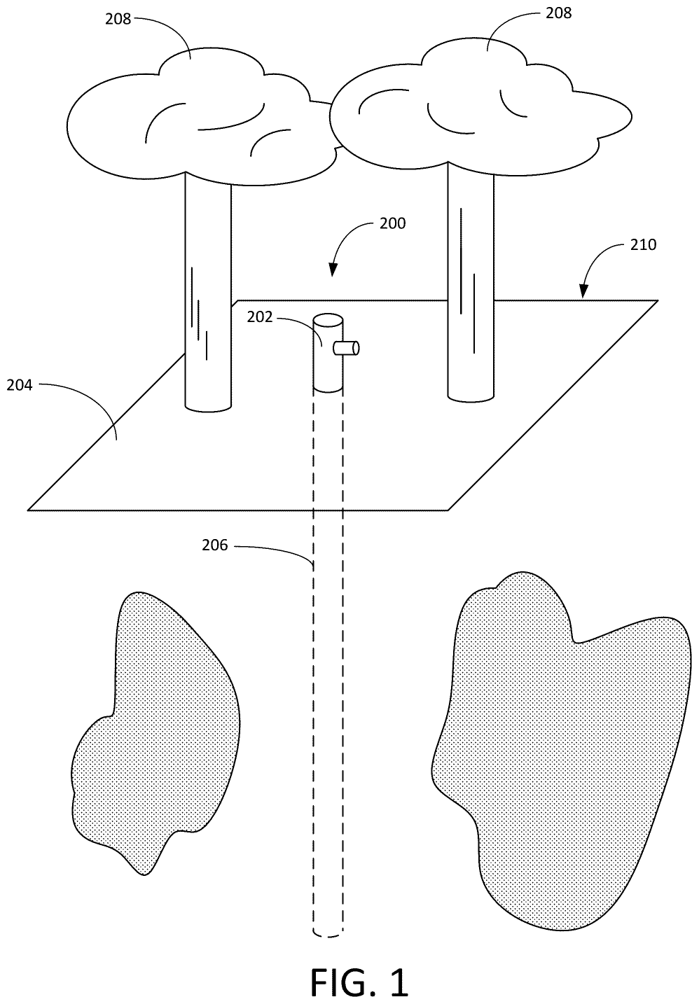

Referring now to the figures of the drawings, wherein like numerals of reference designate like elements throughout the several views, and initially to FIG. 1, depicted therein is a well 200, which may have been drilled for the production of petroleum products (e.g., crude oil or natural gas), water, minerals, or for geothermal energy purposes. As illustrated, the well 200 includes surface components 202 located above the ground 204 and subsurface components 206 that extend below the ground 204. For many wells 200, the surface components include a wellhead, artificial lift equipment, valves, storage equipment, pressure vessels and pipes. The subsurface components 206 often include the well casing, production tubing and other downhole equipment that remains in the well 200. It will be appreciated that for many abandoned or orphaned wells 200, the surface components 202 may have been previously removed or destroyed, leaving the subsurface components 206 more difficult to locate from a visual inspection. In many rural areas, trees, shrubs or other obscuring vegetation 208 make it particularly difficult to visually locate wells 200 once the larger surface components 202 have been removed, destroyed or buried.

The well 200 includes a number of ferromagnetic components. In particular, the subsurface components 206 often include thousands of feet of cylindrical well casing manufactured from carbon steel or other iron-based alloys. The well 200 is located in a survey area 210 that may include multiple wells 200. As explained herein, the magnetic permeability, geometry, orientation and size of the well 200 each contribute to a distinctive and readily observable magnetic anomaly signature based on the interactions with Earth's magnetic field.

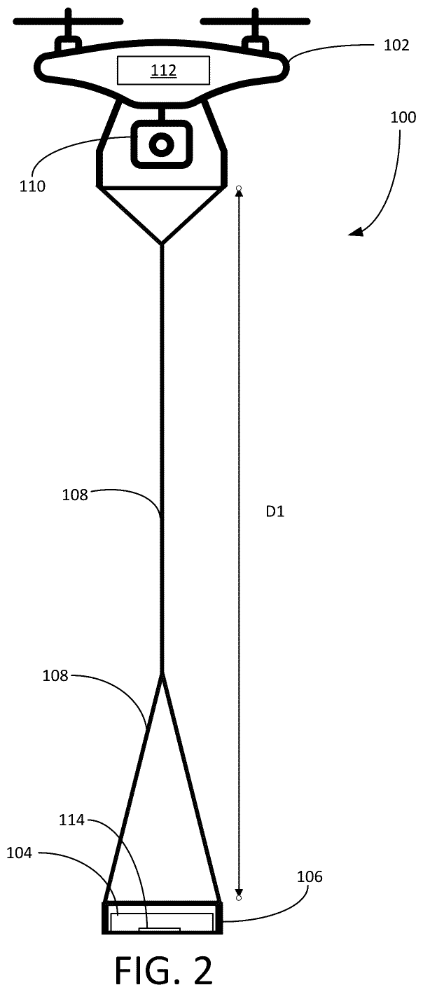

Turning to FIG. 2, shown therein is an aerial detector device 100 constructed in accordance with exemplary embodiments. The aerial detector device 100 includes an unmanned aerial vehicle (UAV) 102, a portable sensor module 104, a sensor housing 106 and suspension straps 108. The UAV 102 can be a commercially available, recreational multi-propeller drone. The UAV 102 can include a camera 110 that is capable of taking high quality photos and videos, which can be stored in a local memory unit 112 on the UAV 102 or streamed through a wireless signal to a remote control system or base station (not shown). The UAV 102 can be manually controlled by an operator or configured for autonomous or semi-autonomous operation with suitable programming.

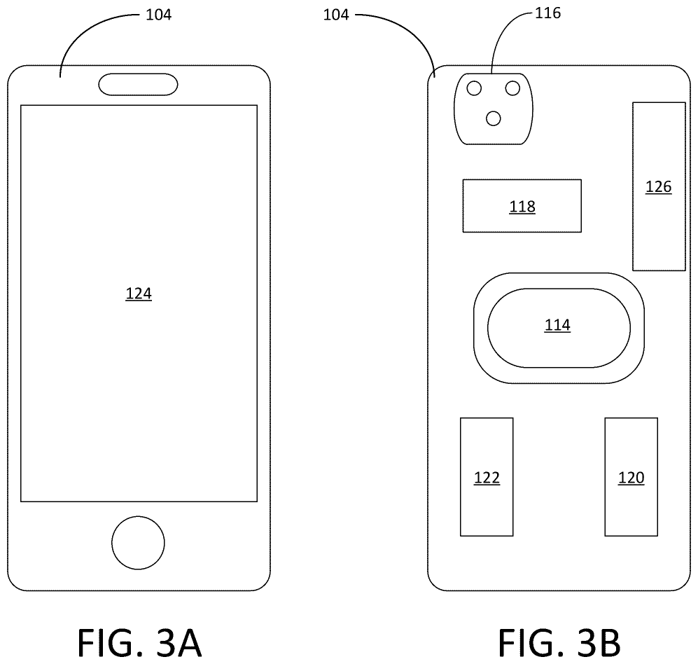

Turning to FIGS. 3A-3B, shown therein are front and back sides, respectively, of the sensor module 104. The sensor module 104 includes a magnetometer 114 that is generally configured to measure magnetic flux fields and in particular identify magnetic anomalies attributable to the well 200 or other ferromagnetic targets in the survey area 210. As used herein, the term “magnetic anomaly” refers to a localized magnetic flux field within a survey area that varies from the baseline magnetic field produced by the Earth in the same survey area. The term “magnetic anomaly signature” refers to a particular type of measured magnetic anomaly that has been correlated with the presence of a particular feature, structure or object in the survey area. The term “well magnetic anomaly signature” refers to the distinctive type of magnetic anomaly signature that is associated with the vertically oriented subsurface components 206 of the well 200 that produce a focused and relatively intense magnetic anomaly signature. More broadly, the term “target magnetic anomaly signature” refers to a magnetic anomaly signature that is associated with a particular ferromagnetic target.

In exemplary embodiments, the sensor module 104 is a standard smartphone that includes an integrated magnetometer. Suitable smartphones include the iPhone 12 Mini smartphone available from Apple Computer, Inc., which includes a high frequency (10-100 Hz), three-axis magnetometer 114 with integrated reset coils. The typical intrinsic noise level for most iPhone magnetometer sensors is rated at 0.1 μT (microtesla) and the resolution is 0.2 μT. The typical anomalous magnetic field of an orphan well 200 varies between 18 μT and 0.4 μT at altitudes of 0.15 meters to 40 meters above ground level (AGL). Thus, these common smartphones are well adapted for detecting the well magnetic anomaly signatures produced by orphaned well 200. As used herein, the term “smartphone” refers to a mobile phone with sufficient processing power and memory to perform many of the functions of a computer, typically having a touchscreen interface, internet access, and an operating system capable of running downloaded applications.

The sensor module 104 optionally includes a camera 116 and a global positioning system (GPS) unit 118. These sensors are also commonly found in commercially available consumer smartphones like the Apple iphone 12 Mini. The GPS unit 118 is configured to track the location of the sensor module 104. The camera 116 is configured to record photographs and video from the sensor module 104. The sensor module 104 also includes onboard memory 120, a processor 122, a display screen 124 and a wireless radio 126. Data produced by the sensors of the sensor module 104 can be stored in the onboard memory 120 or transferred to a remote computer or smartphone through the wireless radio 126. The sensor module 104 can be remotely controlled through a wireless network established with the wireless radio 126.

In exemplary embodiments, the sensor module 104 is configured to execute a detection computer software program in which measurements made by the magnetometer 114 are synchronized with location information generated by the GPS unit 118. In exemplary embodiments, the detection program is configured to plot the location of each occurrence of a magnetic anomaly on mapping software loaded on the sensor module 104.

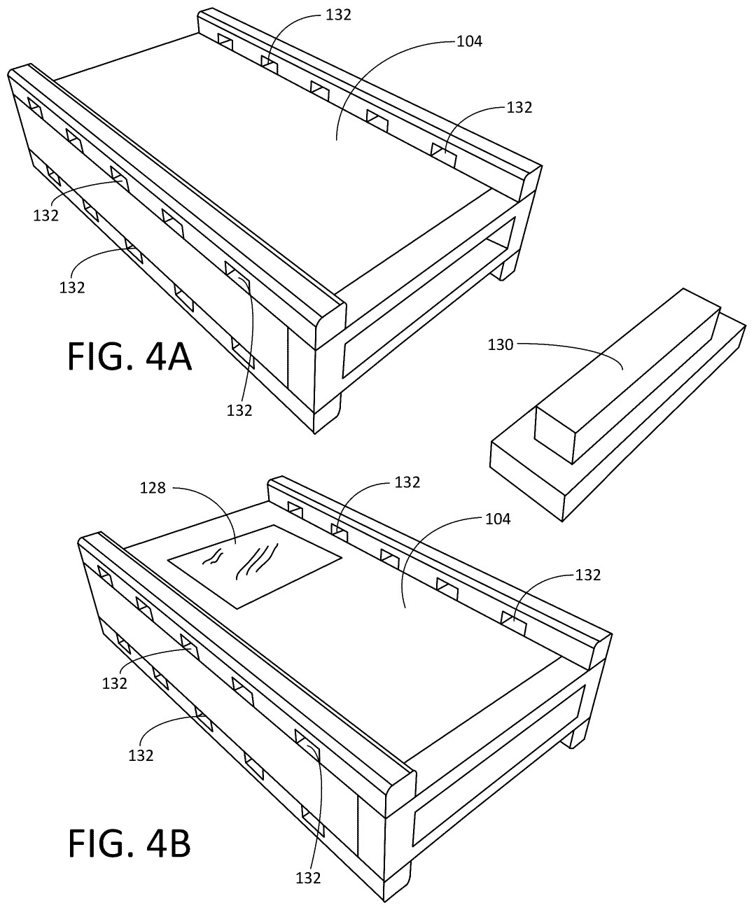

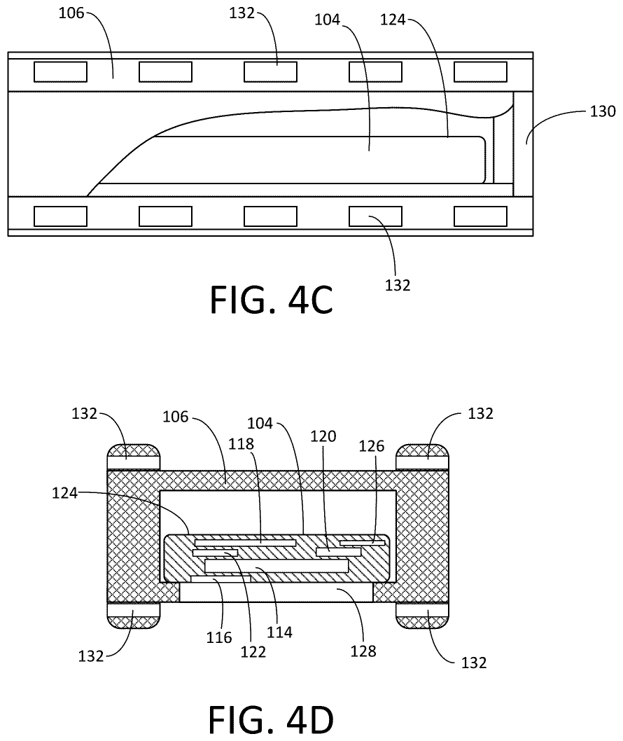

The sensor module 104 is contained in the sensor housing 106. As illustrated in FIGS. 4A-4D, the sensor housing 106 can be constructed from plastic or a non-interfering metal alloy. In some embodiments, the sensor housing 106 may include a transparent window 128 (FIG. 4B) on the bottom side that enables the sensor module 104 to take photographs, video or LiDAR readings (if applicable) with the embedded camera 116. The sensor housing 106 can include a cap 130 (FIG. 4) that permits the facilitated insertion and removal of the sensor module 104 from the sensor housing 106.

The sensor housing 106 includes strap mounts 132 (FIG. 4) that provide a mechanism for attaching the suspension straps 108, which are in turn connected to the UAV 102. The suspension straps 108 are non-magnetic and have an adjustable length (D1). In exemplary embodiments, the suspension straps 108 are manufactured from a synthetic fabric webbing and have a length (D1) of about 1.5 meters. This positions the sensor module 104 below the UAV 102 by a height sufficient to mitigate signal interference between the sensor module 104 and the UAV 102.

In some embodiments, the sensor housing 106 includes aerodynamic features that stabilize the sensor housing 106 during flight. The sensor housing 106 can incorporate fins, cones, wings or other aerodynamic features that improve the stability of the tethered sensor housing 106 during flight, including in response to propwash from the UAV 102, winds and drag resistance from movement of the UAV 102 through the survey area 210.

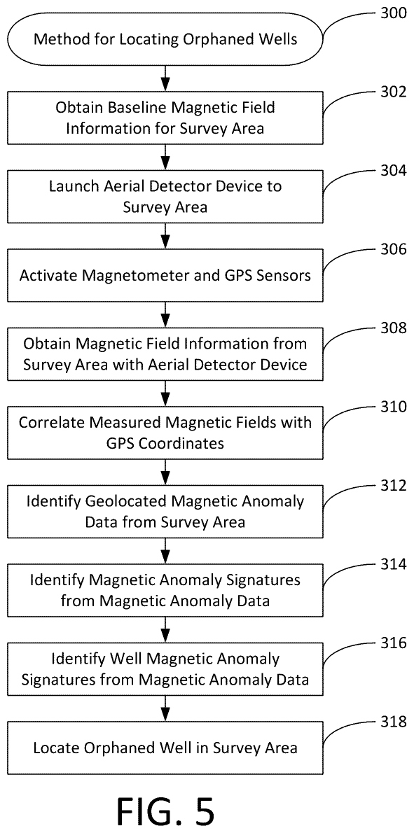

Turning to FIG. 5, shown therein is a flowchart for a method 300 for locating an orphaned well 200. It will be understood that the method 300 is a non-limiting example of suitable method for locating orphaned wells using the aerial detector device 100. The method 300 can include additional steps not presented in FIG. 5. In some embodiments, steps depicted in FIG. 5 may be omitted from the method 300. Although the method 300 is disclosed with reference to locating the orphaned well 200, the method 300 can also be used to locate other ferromagnetic targets within the survey area 210.

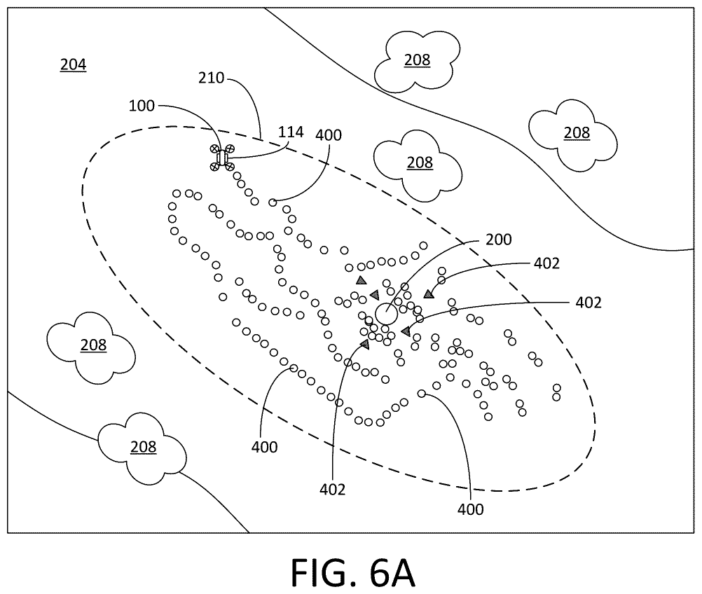

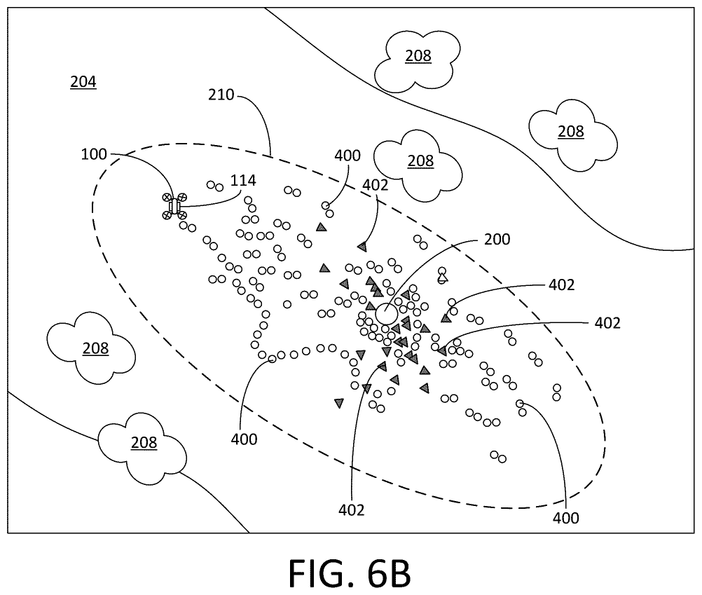

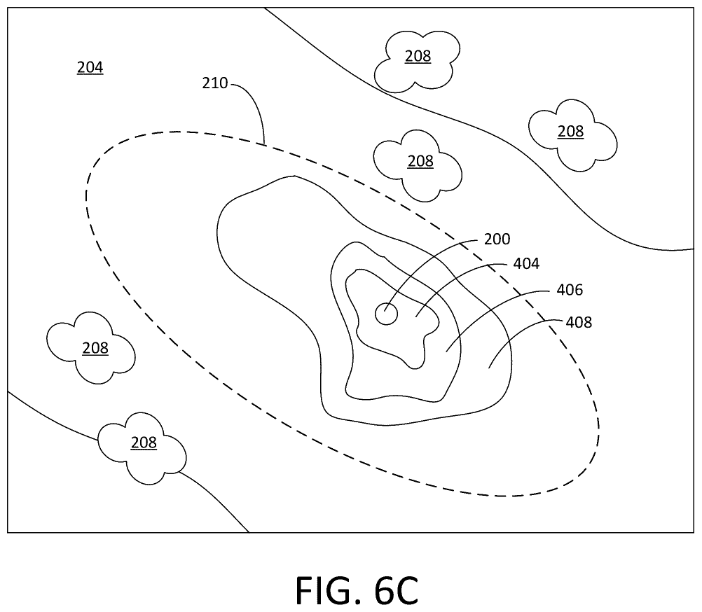

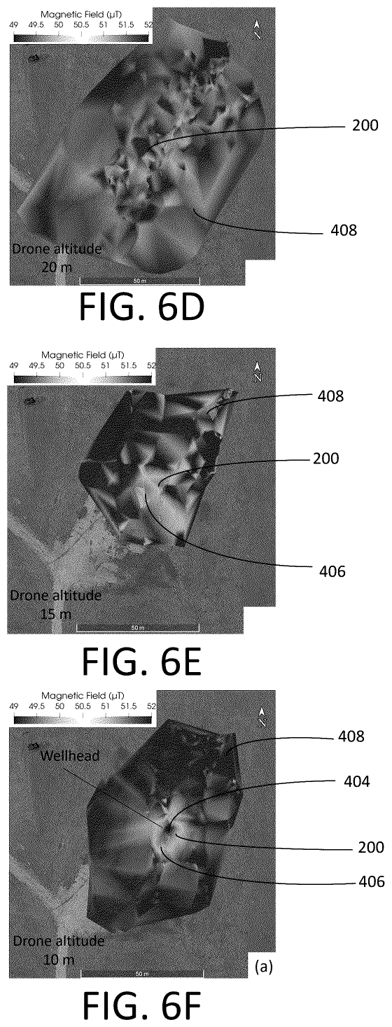

The method begins at step 302 by obtaining information about the baseline magnetic fields present in the survey area 210, as depicted in FIG. 6A. The baseline magnetic field information can be obtained by taking sample measurements 400 using the magnetometer 114 at one or more locations within the survey area 210. The baseline magnetic field information can be obtained using the sensor module 104 or a separate magnetometer device (e.g., a separate smartphone). In some embodiments, it may not be necessary to obtain the baseline magnetic field information at step 302. In other embodiments, the baseline magnetic field information is obtained after the aerial detector device 100 has obtained measurements from the survey area 210.

At step 304, the aerial detector device 100 is launched or flown into the survey area 210. The magnetometer 114 and GPS unit 118 can be activated at launch or turned on as the aerial detector device 100 enters the survey area 210 at step 306. At step 308, the aerial detector device 100 is flown through the survey area 210 while collecting measurement data from the magnetometer 114 and GPS unit 118. The aerial detector device 100 can be remotely controlled by an operator or flown in a semi-autonomous state by executing a pre-programmed search pattern over the survey area 210. In some embodiments, the magnetic flux measurements and location data are sampled at between about 1 and 100 samples/second.

The measurement data produced by the sensor module 104 can be stored locally in the onboard memory 120 or streamed back to the base station through a wireless connection from the wireless radio 126. The aerial detector device 100 can be flown at a range of altitudes depending on the terrain, the weather conditions, the presence of obscuring vegetation 208, and the strength and sensitivity of the magnetometer 114. In exemplary embodiments, the sensor module 104 is suspended at an altitude of between about 5 meters and 30 meters above the ground 204. Higher resolution magnetic field data is available by flying the UAV 102 at an altitude of between about 10 and 15 meters above the ground 204. As the UAV 102 traverses the survey area 210, the magnetometer 114 obtains discrete magnetic flux measurements 400 that are coupled or otherwise associated with corresponding location data from the GPS unit 118 at step 310.

At step 312, geolocated magnetic anomalies 402 are determined by examining the magnetic field measurements taken by the aerial detector device 100 during the flight over the survey area 210. The magnetic anomalies 402 represent sudden or gradual increases in the intensity of the measured magnetic fields over a given traversal distance or area within the survey area 210. In some cases, the magnetic anomalies 402 are identified by removing the baseline magnetic field information obtained at step 302 from the magnetic field measurements 400 obtained at step 308. In other embodiments, the magnetometer 114 can be calibrated (e.g., tuned for less sensitivity) or otherwise configured to only return magnetic field measurements with signal strengths that fall above the baseline magnetic field present across the survey area 210. In those embodiments, it may not be necessary to remove the baseline magnetic field information from the magnetic field measurements taken by the aerial detector device 100 during the flight over the survey arca 210.

At step 314, magnetic anomaly signatures are identified from the magnetic anomaly data. The magnetic anomaly signatures are geolocated and may reflect objects or structures within the survey area 210 that impact the Earth's magnetic field. At step 316, the method calls for the identification of the specific well magnetic anomaly signatures from the magnetic anomaly data. The well magnetic anomaly signatures may be represented as monopole magnetic fields with a focused presentation around the well 200. It will be appreciated that the processing steps 310-316 can be done using a manual review process or through a computer-implemented automated review process that involves comparing the magnetic anomaly data against a database of magnetic anomaly signatures (including the well magnetic anomaly signature). Once the geolocated well signature anomaly data has been identified at step 316, the operator can use the geolocations matching the well signature anomaly data to locate the wells 200 within the survey area 210 at step 318.

To aid in the location of the well 200 from the geolocated magnetic anomaly data, the aerial detector device 100 can also be configured to take pictures or video during the entire flight through the survey area 210 or when the magnetometer 114 measures a magnetic field that exceeds a threshold value (either in duration, area or signal amplitude). The photos and video can be taken by the camera 116 on the sensor module 104, the camera 110 on the UAV 102, or both. The photos and videos can be coupled or otherwise correlated with the corresponding magnetic field measurements using the common GPS location information. In case that the sensor is equipped with a LiDAR sensor (e.g., Apple iPhone 14 pro and newer), the operator can record LiDAR readings by the camera 116 on the sensor module 104 to aid in finding the well 200.

Using the method 300, the aerial detector device 100 is well suited for identifying orphaned wells 200, even if the orphaned well 200 no longer includes a surface component 202. FIGS. 6A-6F provide sample outputs of well signature anomaly data for a well 200. The well signature anomaly data depicted in FIG. 6A represents the geolocated magnetic field measurements taken by the magnetometer 114 when the UAV 102 is positioned at an altitude of about 20 meters above the well 200. FIG. 6B presents the geolocated flux measurements for the same well 200 when the UAV 102 is positioned at an altitude of about 15 meters above the well 200. In FIG. 6A, the aerial detector device 100 made a number of magnetic field measurements 400 and identified a handful (five) magnetic anomalies 402, where the flux readings exceeded the background magnetic flux measurements 400. These magnetic anomalies 402 were clustered around the orphaned well 200. In contrast, the output from the aerial detector device 100 flying at about 10 meters AGL is significantly better at detecting magnetic anomalies 402, which again are clustered around the well 200. This suggests that the aerial detector device 100 performed better when flown at 10 meters AGL than at 15 meters AGL for this particular well 200.

Although mapping discrete magnetic field measurements 400 and magnetic anomalies 402 can be helpful in identifying a magnetic anomaly signature that corresponds to an orphaned well 200 or other ferromagnetic target, the measurements can be overlapping within the survey area 210, which could lead to erroneous data interpretation. Accordingly, it may be useful to produce aggregated magnetic field intensity maps based on the discrete measurements 400 and magnetic anomalies 402 to better illustrate the likely location of the well 200 or other ferromagnetic target. For example, FIG. 6C depicts a basic relief map that depicts a high aggregated intensity zone 404, a moderate aggregated intensity zone 406, and a low aggregated intensity zone 408. As illustrated in FIG. 6C, the smaller high aggregated intensity zone 404 tightly surrounds the orphaned well 200. The aggregated magnetic field intensity maps can be produced using any number of processing algorithms or methods, including the Delaunay triangulation approach using ParaView's Delaunay 2D filter. The aggregated magnetic field intensity maps can then be georeferenced using the open-source QGIS software and superimposed on satellite images of the survey area 210. Due to the strong magnetic signals associated with the vertical steel-cased wells, the orphaned well 200 produces a well magnetic anomaly signature on the aggregated magnetic field intensity map that appears as a strong monopole (high intensity features). In many cases, the well magnetic anomaly signature has a sufficiently high intensity that no data cleaning or filtering is required to enhance the signal-to-noise ratio to locate the wells 200. In some embodiments, lower intensity magnetic anomaly readings 402 can be disregarded and omitted from the magnetic field intensity maps. These lower-intensity magnetic anomaly readings 402 may have resulted from the swinging or other unintended motion of the magnetometer 114 below the UAV 102.

FIGS. 6D-6F depict colorized and shaded magnetic field intensity maps that are generated by the magnetic measurements 400 and magnetic anomalies 402 detected by the aerial detector device 100 during measurements within the survey area 102 at 20 meters AGL, 15 meters AGL, and 10 meters AGL, respectively. Comparing the magnetic flux measurements in FIGS. 6D-6F illustrates the additional resolution available when the magnetometer 114 is located closer to the well 200. In particular, the well signature magnetic anomaly data in FIG. 6F (10 meters AGL) provides a more accurate identification of the well 200.

Accordingly, in one aspect, the aerial detector device 100 is configured to locate ferromagnetic objects in the survey area 210, where the aerial detector device 100 includes the unmanned aerial vehicle (UAV) 102, the sensor housing 106 suspended from the UAV 102, and the sensor module 104 inside the sensor housing 106. The sensor module 104 includes the magnetometer 114 and the GPS unit 118. The sensor module 104 can be a smartphone.

In another aspect, the aerial detector device 100 can be used for locating a ferromagnetic target within the survey area 210. This begins with the step of providing the aerial detector device 100 that includes the sensor module 104 with the magnetometer 114 and the global positioning system (GPS) unit 118. The sensor module 104 can be a consumer smartphone. The method continues with the steps of launching or flying the aerial detector device 100 into the survey arca 210, activating the magnetometer 114 and GPS unit 118 to obtain magnetic field measurements and location information, correlating the magnetic field measurements with corresponding location information to produced geolocated magnetic field data, identifying geolocated magnetic anomaly data from the geolocated magnetic field data, identifying one or more magnetic anomaly signatures from the geolocated magnetic anomaly data, selecting a target magnetic anomaly signature from the one or more magnetic anomaly signatures from the geolocated magnetic anomaly data, and determining the location of the ferromagnetic target from the location information associated with the target magnetic anomaly signature. The method optionally includes the steps of obtaining baseline magnetic field information for the survey area 210 and removing the baseline magnetic field information from the geolocated magnetic field data to identify the geolocated magnetic anomaly data. Although the method is not so limited, the ferromagnetic target can be an orphaned well 200.

Thus, the embodiments of the present disclosure are well adapted to carry out the objects and attain the ends and advantages mentioned above, as well as those inherent therein. The aerial detector device 100 provides a cost-effective system for carrying out low-altitude, high resolution magnetic field surveys that may find particular utility in locating orphaned wells in unimproved land. The aerial detector device 100 can be an order of magnitude less expensive that commercial aerial magnetometer systems while providing high resolution measurements using relatively simple control systems. While the aerial detector device 100 has been described and illustrated herein by reference to particular non-limiting embodiments in relation to the drawings attached thereto, various changes and further modifications, apart from those shown or suggested herein, may be made therein by those of ordinary skill in the art, without departing from the spirit of the inventive concepts.

It is claimed:

1. An aerial detector device configured to locate ferromagnetic objects in a survey area, the aerial detector device comprising:
an unmanned aerial vehicle;
a sensor housing suspended from the unmanned aerial vehicle; and
a sensor module inside the sensor housing, wherein the sensor module comprises:
a magnetometer; and
a GPS unit.

2. The aerial detector device of claim 1, wherein the sensor module is a smartphone.

3. The aerial detector device of claim 2, wherein the unmanned aerial vehicle is a recreational drone.

4. The aerial detector device of claim 2, wherein the smartphone further comprises a camera.

5. The aerial detector device of claim 4, wherein the sensor housing comprises a window to permit the camera to take photographs from inside the sensor housing.

6. A method for locating a ferromagnetic target within a survey area, the method comprising the steps of:
providing an aerial detector device that includes a sensor module with a magnetometer and a global positioning system (GPS) unit, wherein the sensor module is a smartphone;
launching the aerial detector device into the survey area;
activating the magnetometer and GPS unit to obtain magnetic field measurements and location information;
correlating the magnetic field measurements with corresponding location information to produced geolocated magnetic field data;
identifying geolocated magnetic anomaly data from the geolocated magnetic field data;
identifying one or more magnetic anomaly signatures from the geolocated magnetic field data;
identifying a target-specific well magnetic anomaly signature; and
determining the location of the ferromagnetic target from the location information associated with the target-specific well magnetic anomaly signature.

7. The method of claim 6, wherein the ferromagnetic target is an orphaned well.

8. The method of claim 6, further comprising a step of obtaining baseline magnetic field information for the survey area.

9. The method of claim 8, wherein the step of identifying geolocated magnetic anomaly data comprises removing from the geolocated magnetic field data the baseline magnetic field information for the survey area.

10. A method for locating an orphaned well within a survey area, the method comprising the steps of:
obtaining baseline magnetic field information for the survey area;
providing an aerial detector device that includes a sensor module with a magnetometer and a global positioning system (GPS) unit, wherein the sensor module is a smartphone;
launching the aerial detector device into the survey area;
activating the magnetometer and GPS unit;
flying the aerial detector device through the survey area;
obtaining magnetic field measurements and location information within the survey area;
correlating the magnetic field measurements with corresponding location information to produced geolocated magnetic field data;
identifying geolocated magnetic anomaly data from the geolocated magnetic field data;
identifying one or more magnetic anomaly signatures from the geolocated magnetic field data;
identifying a well magnetic anomaly signature from the one or more magnetic anomaly signatures; and
determining the location of the orphaned well from the location information associated with the well magnetic anomaly signature.

11. The method of claim 10, wherein the step of identifying geolocated magnetic anomaly data comprises removing from the geolocated magnetic field data the baseline magnetic field information for the survey area.

12. The method of claim 10, wherein the step of identifying geolocated magnetic anomaly data comprises discarding magnetic field measurements that fall below a threshold intensity.

13. The method of claim 10, wherein the step of providing the aerial detector device that includes the sensor module with the magnetometer and the global positioning system (GPS) unit, further comprises the steps of:
placing the smartphone into a sensor module;
connecting one or more straps to the sensor module; and
connecting the one or more straps to a UAV.

14. The method of claim 13, wherein the step of connecting the one or more straps to the UAV further comprises connecting the one or more straps to a consumer-grade drone.

15. The method of claim 14, connecting the step of flying the aerial detector device through the survey area comprises flying the aerial detector device through the survey area at a height of between about 5 meters and 30 meters above ground level.

16. The method of claim 15, connecting the step of flying the aerial detector device through the survey area comprises flying the aerial detector device through the survey area at a height of between about 10 meters and 20 meters above ground level.

17. The method of claim 16, connecting the step of flying the aerial detector device through the survey area comprises flying the aerial detector device through the survey area at a height of about 10 meters above ground level.

18. The method of claim 10, wherein the step of flying the aerial detector device through the survey area comprises manually controlling the aerial detector device as it flies through the survey area.

19. The method of claim 10, wherein the step of flying the aerial detector device through the survey area comprises programming the aerial detector device to follow a predetermined flight path through the survey area.

20. The method of claim 10, further comprising the step of generating an aggregated magnetic field intensity map before the step of identifying one or more magnetic anomaly signatures from the geolocated magnetic field data.
